(19) United States
(12) Patent Application Publication
(10) Pub. No.: US 2010/0070117 A1
(43) Pub. Date: Mar. 18, 2010

(54) Method and Apparatus for Locomotive Apparatus

(75) Inventor: Jack A. Siffert, Elyria, OH (US)

Correspondence Address: BROUSE MCDOWELL LPA, 388 SOUTH MAIN STREET, SUITE 500, AKRON, OH, 44311, US

(73) Assignee: INDUSTRIAL RAILWAY SWITCHING & SERVICES, INC., Lorain, OH (US)

(21) Appl. No.: 12/556,493

(22) Filed: Sep. 9, 2009

Related U.S. Application Data
(60) Provisional application No. 61/095,447, filed on Sep. 9, 2008.

(51) Int. Cl. G05D 1/00; G06F 17/00; B61C 17/00

(52) U.S. Cl. 701/19; 105/26.05

(57) ABSTRACT

A locomotive engine comprising an increased efficiency relative to conventional locomotive engines is disclosed. The locomotive engine may comprise components having an increased efficiency relative to conventional components and/or may comprise a system for operating the engine components more efficiently relative to systems for operating the components of conventional locomotive engines. Further, the locomotive engine may comprise modular components that can be readily installed or removed from the locomotive engine.

### I. BACKGROUND

A. Field of Invention

This invention pertains to the art of methods and apparatuses of locomotive engines and even more particularly, to the art of methods and apparatuses of increased efficiency locomotive engines.

B. Description of the Related Art

Locomotive engines, or Engines, provide a number of important rail transport services. In addition to providing motive power for cars, Engines provide power for braking and provide electrical power.

Although known devices work well for their intended purpose, several disadvantages exist. Conventional Engines tend to have very low efficiencies in a variety of their systems. For example, railway adhesion in conventional adhesion driven Engines is quite low; 10-14% is not an unusual adhesion range. Because adhesion rates are linearly related to work output, developing Engines with higher adhesion rates promotes engine efficiency.

What is needed is an increased efficiency Engine.

### II. SUMMARY

According to one embodiment of the invention, a locomotive may comprise a centralized computer control, a traction control system, and an air compressor apparatus. The centralized control computer may comprise an automated engine start and stop system; an engine heater control; and, a cooling fan control. The traction control system may comprise a first sensor for determining slippage conditions at a first wheel; and, a switching control adapted to switch power to and from the first wheel.

According to another embodiment of the invention, a locomotive may comprise a modular centralized computer control comprising: an automated engine start and stop system; an engine heater control; and, a cooling fan control; a modular traction control system comprising: a first sensor for determining slippage conditions at a first wheel; and, a switching control adapted to switch power to and from the first wheel; a modular air compressor apparatus; a modular main power unit comprising: a first internal combustion engine; a first alternator adapted to provide three-phase alternating current; and, a first chopper, a modular auxiliary power unit comprising: a second internal combustion engine; a second alternator adapted to provide three-phase alternating current; and, a second chopper; a modular braking system; and, a modular radiator assembly, wherein the modular main power unit provides a first amount of power sufficient to drive the apparatus while the apparatus is operatively connected to at least a first railroad car and the modular auxiliary power unit provides a second amount of power sufficient to drive the apparatus.

According to another embodiment of the invention, a modular component for a locomotive engine may comprise: a connection element for facilitating the ready installation or removal of the modular component; and, a roller assembly comprising: a slider assembly having a first channel, a second channel and a plurality of center channels extending between the first and second channels, wherein the first, second, and center channels define a first upper surface suitable to receive the modular component; a bottom frame assembly having a third channel, a fourth channel, and a plurality of center channels extending between the third and fourth channels, wherein the third and fourth channels are suitable to receive at least a portion of the first and second channels respectively; and, a plurality of rotating assemblies rotatably connected to the first and fourth channels, wherein the plurality of rotating assemblies allow the slider assembly to slide across an upper surface of the bottom frame assembly defined by the third, fourth and center channels of the bottom frame assembly.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows a perspective view, generally, of a locomotive engine according to one embodiment of the invention;

FIG. 2 shows a perspective view of an engine that can be used in a locomotive engine according to one embodiment of the invention;

FIG. 3 shows a perspective side view of an engine that can be used in a locomotive engine according to one embodiment of the invention;

FIG. 4 shows a perspective side view of an engine that can be used in a locomotive engine according to one embodiment of the invention;

FIG. 5 shows a block diagram view of a centralized control system according to one embodiment of the invention;

FIG. 6 shows a perspective view of an operator compartment according to one embodiment of the invention;

FIG. 7 shows a perspective view of an operator compartment according to one embodiment of the invention;

FIG. 8 shows a perspective view of an operator compartment according to one embodiment of the invention;

FIG. 9 shows a perspective view of an operator compartment according to one embodiment of the invention;

FIG. 10 shows a perspective view of an operator compartment according to one embodiment of the invention;

FIG. 11 shows a perspective view of an operator compartment according to one embodiment of the invention;

FIG. 12 shows a perspective view of an operator compartment according to one embodiment of the invention

FIG. 13a shows a perspective view of a IGBT chopper according to one embodiment of the invention;

FIG. 13b shows a perspective view of a IGBT chopper according to one embodiment of the invention;

FIG. 13c shows a perspective view of a IGBT chopper according to one embodiment of the invention;

FIG. 14 shows a perspective view of a mount assembly of a modular component, such as, for example, an air compressor, of a locomotive engine according to one embodiment of the invention;

FIG. 15 shows a perspective view of a slider assembly for a mount assembly of a modular component of a locomotive engine according to one embodiment of the invention;

FIG. 15a shows a partial side perspective view of the right channel of the slider assembly shown in FIG. 15;

FIG. 16 shows a perspective view of a bottom frame assembly of a mount assembly of a modular component of a locomotive engine according to one embodiment of the invention.

### IV. DETAILED DESCRIPTION

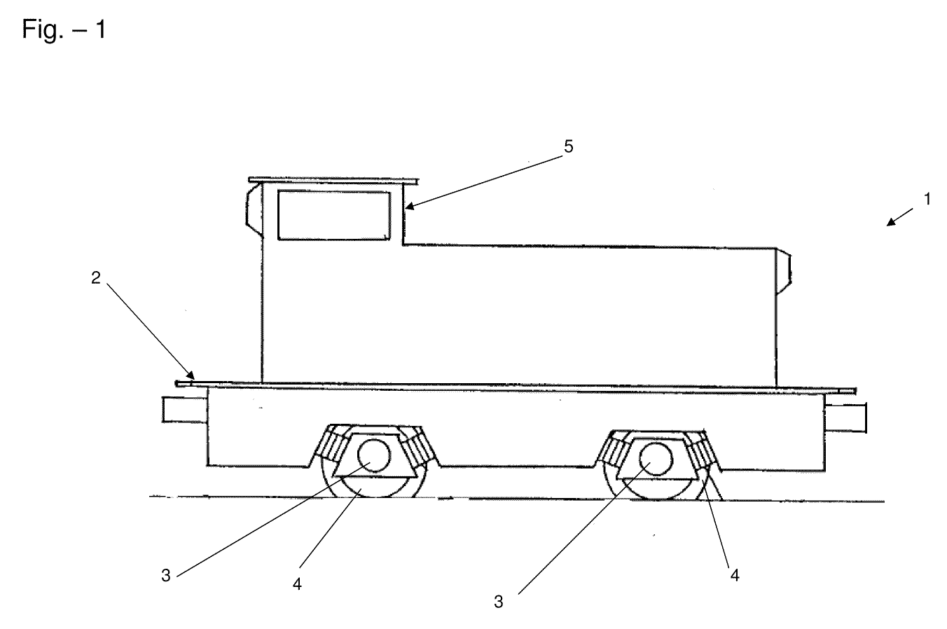

Referring now to the drawings wherein the showings are for purposes of illustrating embodiments of the invention only and not for purposes of limiting the same, FIG. 1 shows an increased efficiency locomotive engine 1 according to one embodiment of the invention. The locomotive engine 1 may allow for a reduction in fuel consumption and emissions relative to similar conventional locomotive engines. The locomotive engine 1 may also comprise one or more modular components that can be readily installed and/or removed from the locomotive engine 1 thereby reducing the time and costs associated with servicing, repair, and maintenance of conventional locomotive engines. The modular components of the locomotive engine 1 may minimize any downtime associated with the repair and maintenance of the locomotive engine 1 by allowing an associated operator to repair and/or replace any of the modular components of the locomotive engine 1 in less than eight hours. By providing for the repair and/or replacement of any modular component of the locomotive engine 1, the locomotive engine 1 allows for an increase in productivity by allowing for the repair and/or replacement of any modular component during a single eight hour work shift thereby eliminating losses in productivity caused by the termination of a work day or shift and/or a change of personnel.

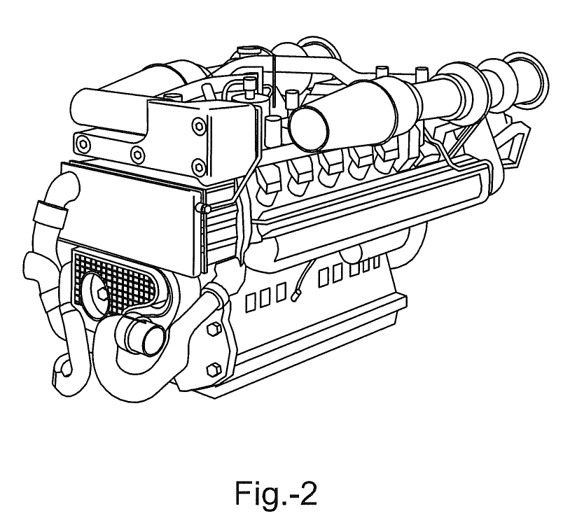

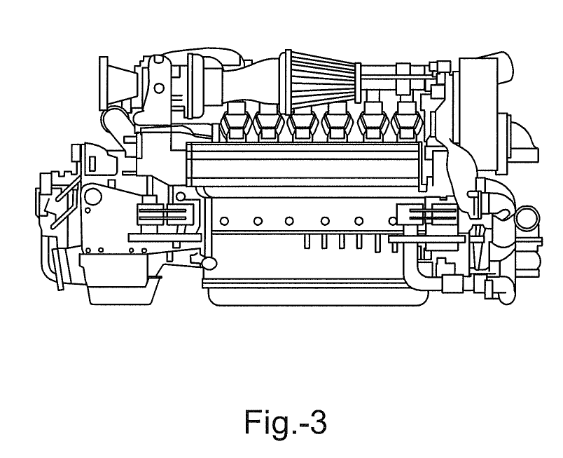

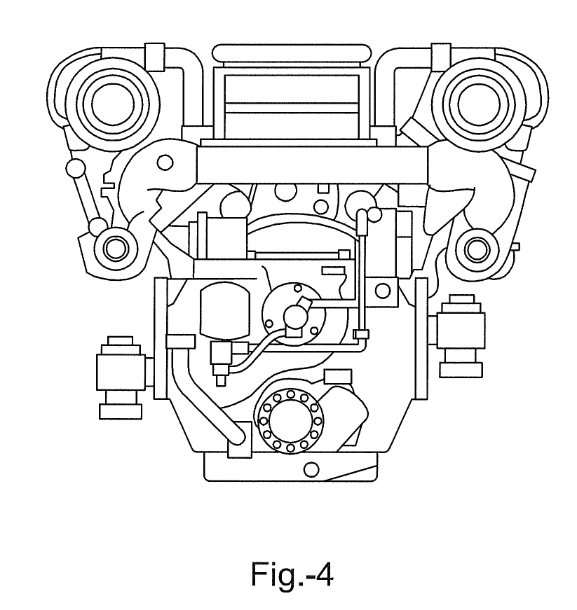

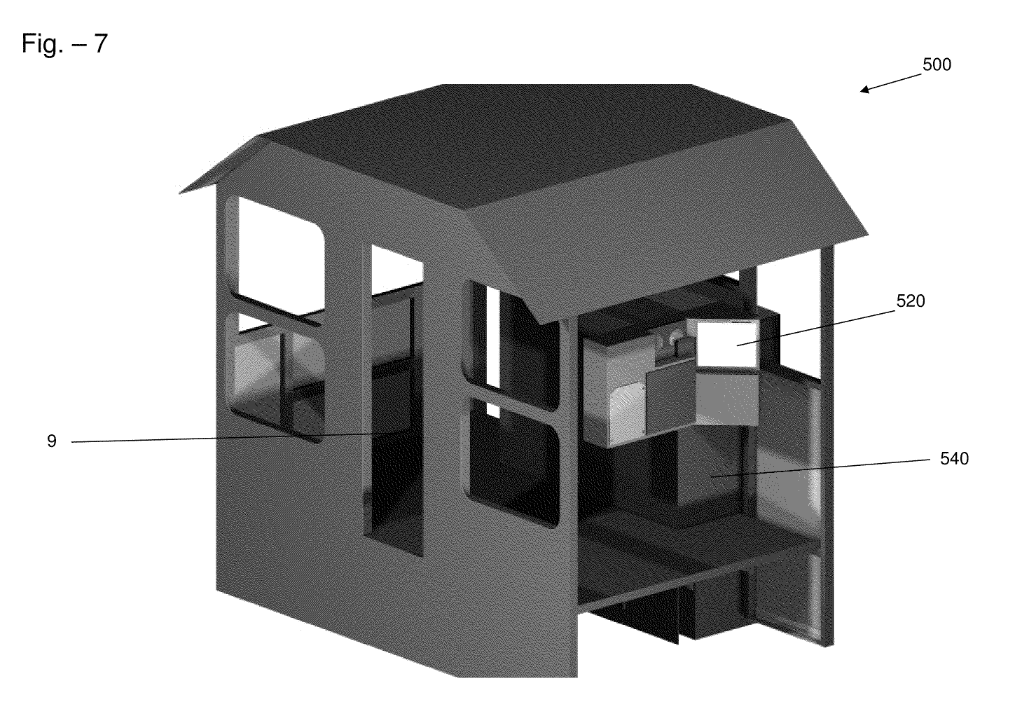

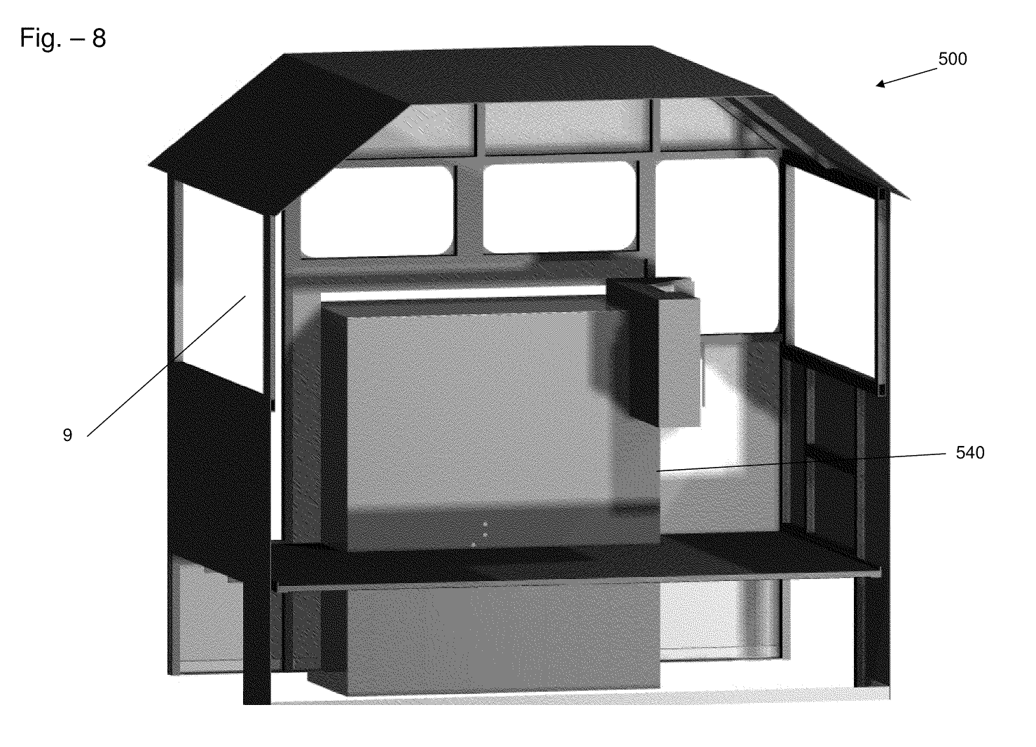

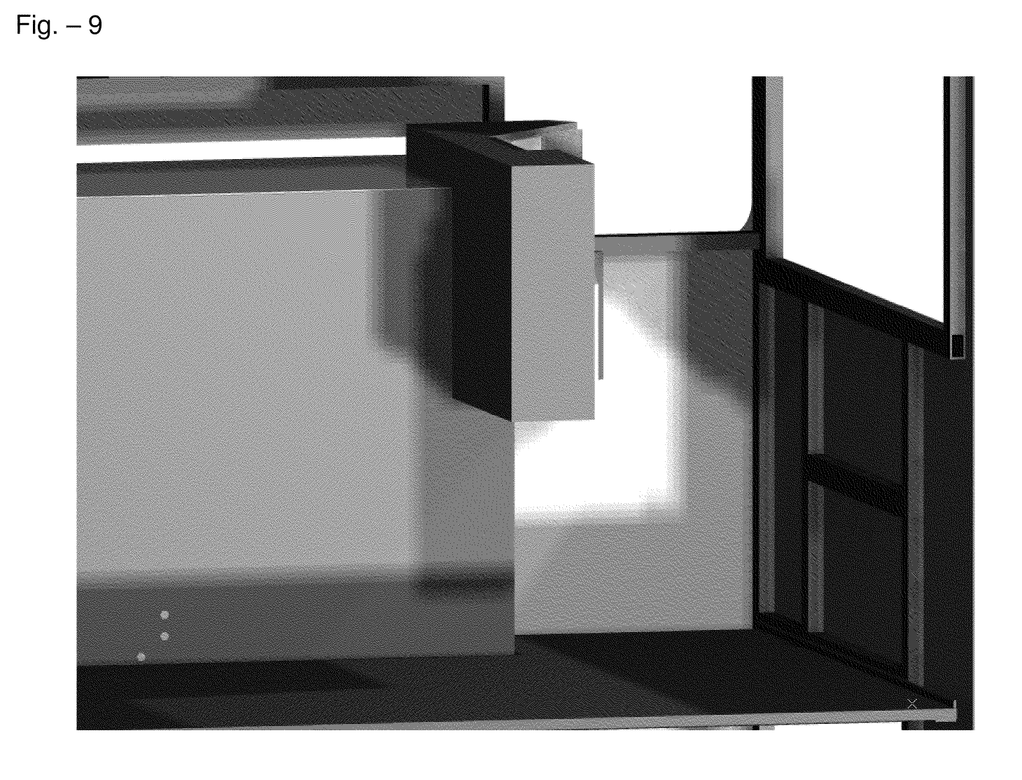

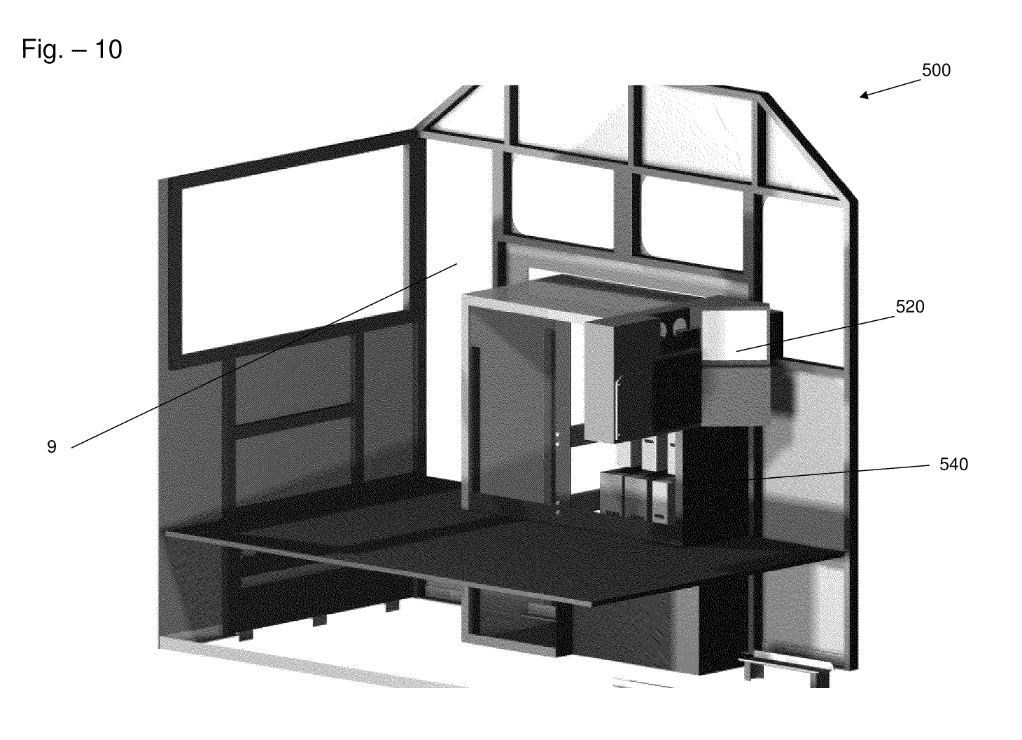

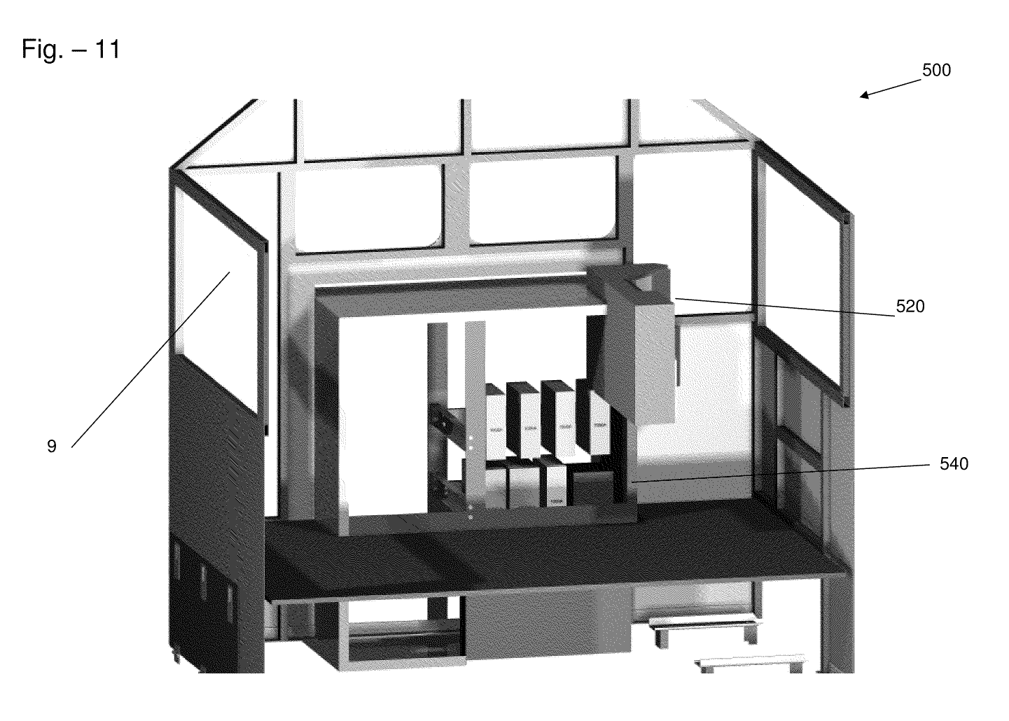

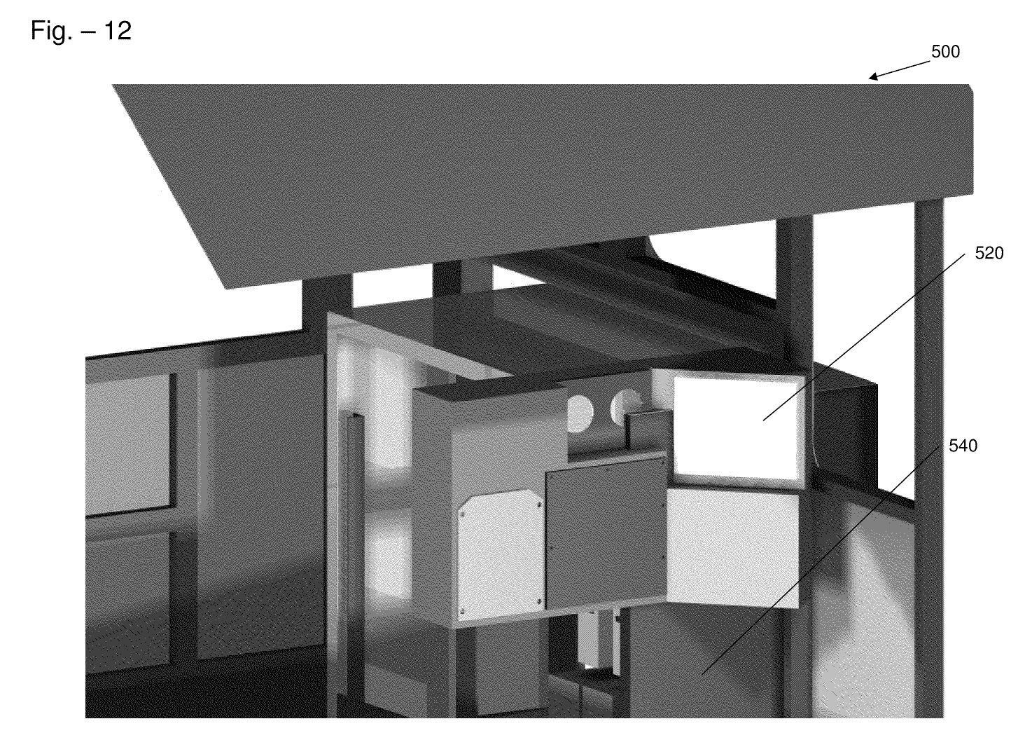

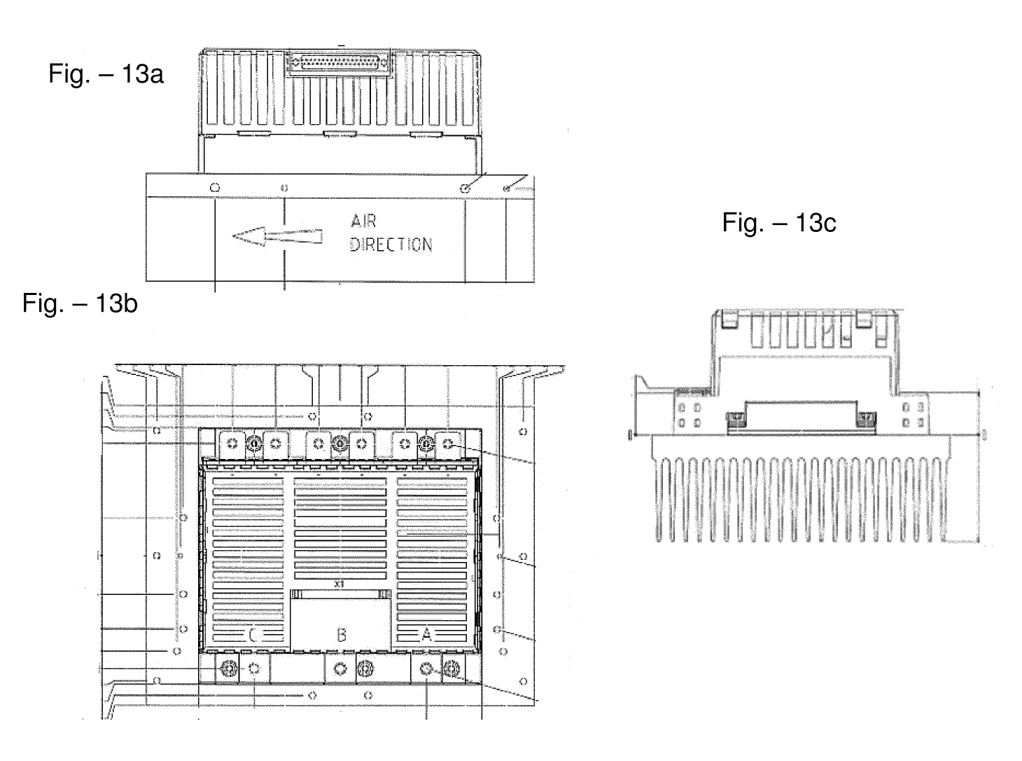

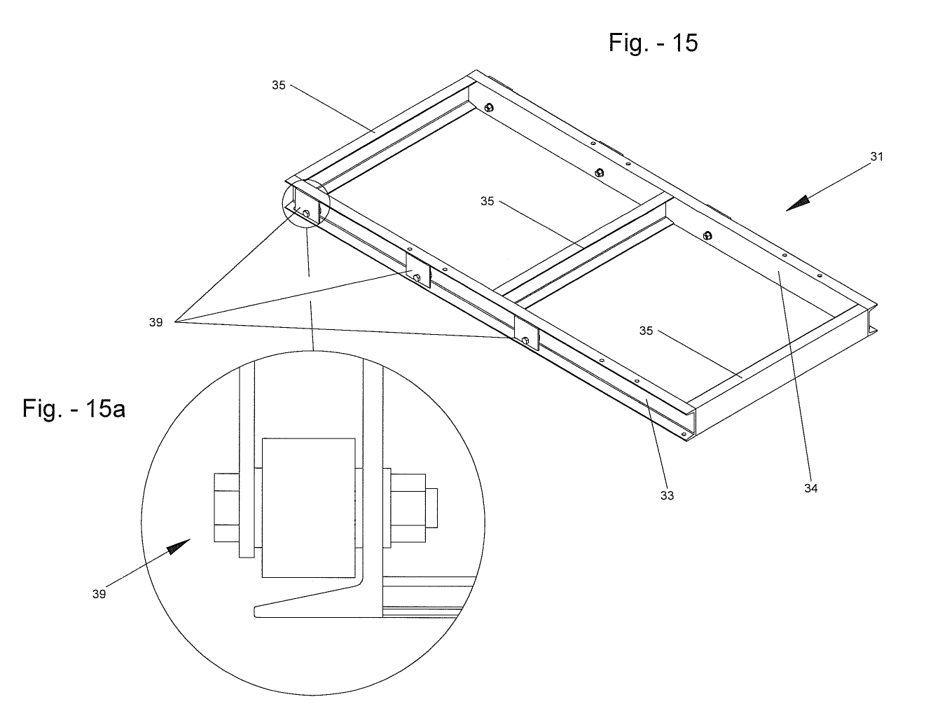

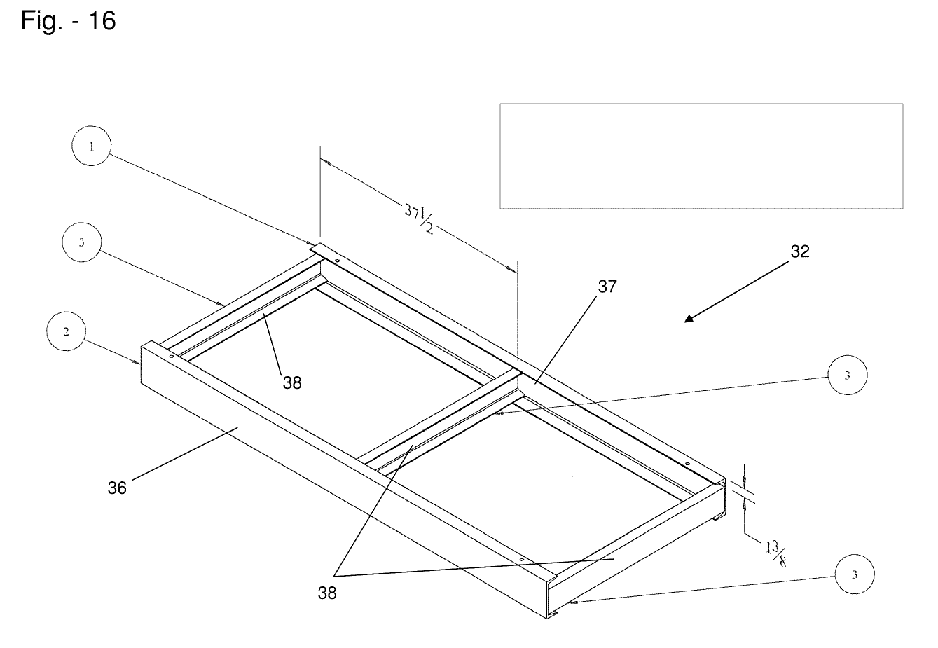

With reference to FIGS. 1-16, the locomotive engine 1 may comprise a locomotive frame 2 and first and second frame-mounted wheel axles 3 mounted to the locomotive frame 2 in a generally fixed relationship. The first and second wheel axles 3 may be longitudinally spaced along a length of the locomotive frame 2 to define a frame wheel base between the center lines of the first and second wheel axles 3. Drive wheels 4 may be carried by opposing ends of the first and second wheel axles 3 for driving the locomotive engine 1 on a rail, not shown, as is well known in the art. An operator cab 5, as more fully described below, may be operatively connected to the locomotive frame 2. In one embodiment, the operator cab 5 may be positioned towards the rearward end of the locomotive frame 2. A railway drive assembly 12 may at least partially enables the locomotive engine 1 to provide motive power for an associated railroad car, not shown. The drive assembly 12 may be operatively connected to the first and second wheel axles 3 and may at least partially enable the locomotive engine 1 to provide motive power by the direct application of force; i.e., by pushing or pulling the railroad car, not shown. The drive assembly 12 may comprise any type of drive assembly, for example, adhesion, funicular, and/or cog, chosen with sound judgment by a person of ordinary skill in the art.

With reference now to FIGS. 1-5, 13-16, in one embodiment, the locomotive engine 1 may comprise a centralized control system 16 for controlling the operation of the locomotive engine 1. The centralized control system 16 may be used gather operational and environmental data regarding the engine and its operating environment and to schedule control events to reduce inefficient operation. The centralized control system 16 may comprise a computer or microprocessor suitable for executing a series of programs to at least partially control the operation of the locomotive engine 1. The centralized control system 16 may comprise a control card that can be programmed to control one or more components of the locomotive engine 1. The control card may comprise a modular component that can be readily installed and/or removed from the centralized control system. The centralized control system 16 may allow for the remote programming of the control card and may allow the control card to be remotely programmed via a cell phone uplink thereby allowing an associated user to program the control card while located apart or remotely from the centralized control system and/or the locomotive engine 1. In one embodiment, the centralized control system may comprise a first, second, third, fourth, and fifth control cards for controlling various components of the locomotive engine 1. The first, second, third, fourth, and fifth control cards may control the AESS system 17, the traction control system 18, the power unit 22, the braking system 24 to include the electric hand brake 27, and a temperature control portion 21 for controlling the engine cooling and heating, respectively, as more fully described below.

In one embodiment, the centralized control system 16 may control engine cooling and heating to maintain desired temperatures of the engine and avoid inefficient engine operational temperatures. In some embodiments, it is desirable for engine operation to occur within some desired operational temperature range. In some embodiments, when the engine falls below a desired operational temperature range or to prevent the engine from falling below a desired operational temperature range, one or more power units may be operated in order to create heat to warm the engine in order to keep or return the engine to a desired operational temperature range. In some embodiments, the main power unit 22 may be run to warm the engine. In some embodiments, the auxiliary power unit 23 may be run to warm the engine. In some embodiments, it is more efficient to run the auxiliary power unit 23 to warm the engine. In one embodiment, the centralized control system 16 may be provided with information about variables related to the equation of idling such as, but not limited to, ambient temperature. The centralized control system 16 may cause an override to occur in order to maintain a temperature conducive to pending operation of the locomotive engine 1, if the temperature falls below a predetermined level.

With reference now to FIGS. 1-5, 13-16, in one embodiment, the centralized control system 16 may comprise an automated engine start and stop (“AESS”) system 17. Improper timing of engine start up and shut-down procedures is a common source of inefficiency whether due to lost duty time, unnecessary idle time, unnecessary wear, or other economic or mechanical concerns. By incorporating the AESS system 17, inefficiencies from poorly timed start up and shut-down procedures can be reduced or eliminated. The AESS system 17 may eliminate or significantly reduce simple human inefficiency resulting from operator distraction or diversion. The AESS system 17 may provide for certain functions to be remotely available where such improved availability correlates to improved efficiency. Unnecessary idle functionality is another source of inefficiency which can be reduced by utilization of the AESS system 17. Automation of idle shut down commands through a timer or other desired automation inputs, can assist in minimizing unnecessary idle time. The AESS system 17 may similarly provide efficient procedures and timing for start-up.

With reference now to FIGS. 1-5, 13-16, in one embodiment, the centralized control system 16 may comprise a traction control system 18. In adhesion-driven locomotive engines, the motive forces between the locomotive engine and the rail are applied through adhesion; the motive forces are frictional and/or adhesive. In some situations, the frictional or adhesive motive forces are diminished. Factors which can diminish frictional or adhesive motive forces include, but are not limited to, grease, oil, ice, water, rain, snow, other forms of precipitation, or debris on the rails. Other factors which can diminish frictional or adhesive forces include factors which diminish normal forces such as a slope, slant, inclination, or declination in the railway. Situations in which the frictional or adhesive forces are diminished or are otherwise insufficient can cause undesired wheel slippage. While wheel slippage is not always undesirable, wheel slippage can be a source of undesirable inefficiency because it uses drive power without providing motive work in return. Diminishment or elimination of undesirable wheel slippage can promote efficiency in adhesion-driven locomotive engines.

With reference now to FIGS. 1-5, 13-16, in one embodiment, the traction control system 18 may comprise a sensor 6 for determining slippage conditions at the drive wheels 4, an axle generator 7 for acquiring data relating to the movement of the drive wheels 4, and a switching control 8 for switching power from the drive wheels 4. The traction control system 18 may be utilized to diminish or eliminate undesirable wheel slippage. The traction control system 18 may acquire data to make determinations regarding wheel slippage and then switch power to or from the drive wheels 4 in accordance with the determined wheel slippage condition. Data taken may include data about the movement of the drive wheels 4 or current to a traction motor 25. Data about the movement of the drive wheels 4 may be taken by an axle generator, not shown. The axle generator, not shown, may acquire shaft input from a mechanical connection to the drive wheels 4 and output one or more signals representative of the wheel performance. Without limitation, signals representative of the wheel performance may include rotation speed. In certain embodiments, if the traction control system 18 determines that one or more of the drive wheels 4 are slipping, the traction control system 18 may at least partially cause power to be shut down or switched from one or more of the drive wheels 4.

The braking system 24 may comprise an apparatus for stopping, slowing, or preventing the movement of the locomotive engine 1. The braking system 24 may apply compressed air to the drive wheels 4 thereby applying a force to a brake assembly, not shown, that utilizes friction to slow, stop, or prevent the movement of the locomotive engine 1, as is well known in the art. In one embodiment, the braking system 24 may comprise a modular component of the locomotive engine 1 that can be readily installed and/or removed from the locomotive engine 1. The braking system 24 may comprise at least a connection element 30 and a roller assembly 29 that increases the modularity and/or portability of the braking system 24 and allows the braking system 24 to be rolled out of the locomotive engine 1. In one embodiment, the disconnection of all of the connection elements 30 of the braking system 24 may cause the braking system 24 to be fully supported by the roller assembly 29 thereby allowing an associated operator to roll the braking system 24 out of the locomotive engine 1 via a side door 9 of the operator cab 5 wherein the braking system 24 can then be picked up utilizing a tow motor or pole and then moved to a desired location for servicing or storing the braking system 24.

With reference now to FIGS. 1-5, 13-16, in one embodiment, the braking system 24 of the locomotive engine 1 may comprise an electric hand brake 27. The electric hand brake 27 may comprise two or more activity states including but not limited to, an active state providing braking forces and an inactive state not providing braking forces. The electric hand brake 27 may be activated to provide braking forces independent of other braking systems, including but not limited to, air brakes, if present. In certain embodiments, the electric hand brake 27 can be either set locally using a manual adjustment or remotely using a remote control system. The electric hand brake 27 may be operatively connected to the centralized control system 16 to provide reductions in the fuel usage and emissions of the locomotive engine 1. Upon setting or engaging the electric hand brake 27, the electric hand brake 27 may transmit a signal to the centralized control system 16. The centralized control system 16 may receive the signal transmitted by the electric hand brake 27 and determine that the electric hand brake 27 is set or engaged. Upon determining that the electric hand brake 27 is set or engaged, the centralized control system 16 may cause one or more functions to be to be overridden, stopped, started, or otherwise controlled, wherein the function overridden, stopped, started, or otherwise controlled is determined to be unnecessary, undesirable, or redundant when the electric hand brake 27 is set or engaged. In one embodiment, upon determining that the electric hand brake 27 is set or engaged, the centralized control system 16 may cause an auto start feature of the AESS system 17 to be overridden. The overriding of the auto start feature may prevent the automatic starting of the locomotive engine 1. The auto start feature may comprise a feature designed for causing the automatic starting of the locomotive engine 1 for various purposes, such as, for one non-limiting example, the purpose of maintaining air pressure utilized in operating the braking system 24. In one embodiment, the electric hand brake 27 may comprise a safety feature wherein the centralized control system 16 causes the electric hand brake 27 to be set or applied automatically in the event a failure occurs within one of the components of the locomotive engine 1.

Reducing or eliminating the maintenance of air pressure for braking power may comprise steps to reduce or prevent the starting or running the air compressor apparatus 20. By reducing or preventing unnecessary starting or running of the air compressor apparatus 20, an energy savings, emissions reduction, and increased efficiency may be realized. In one embodiment, the electric hand brake 27 may be interfaced with the centralized control system 16. The centralized control system 16 may be provided with information about the activity state of the electric hand brake 27. In one embodiment in which the centralized control system 16 is provided with information about the activity state of the electric hand brake 27, an active hand brake state indicates that the locomotive engine 1 is securely parked. In one embodiment in which the centralized control system 16 is provided with information about the activity state of the electric hand brake 27, when the electric hand brake state is active, the centralized control system 16 may take measures to reduce, minimize, or eliminate activity in redundant braking systems of the braking system 24. In one embodiment in which the centralized control system 16 is provided with information about the activity state of the electric hand brake 27, when the electric hand brake state is active, the default setting is for the centralized control system 16 to take measures to reduce, minimize, or eliminate activity in redundant braking systems of the braking system 24.

With reference now to FIGS. 1-5, 13-16, the locomotive engine 1 may comprise an air compressor apparatus 20. The air compressor apparatus 20 may be used to provide, without limitation, compressed air for the braking system 24. Compressed air is a common way to transmit power and/or cooling fluid, for diverse engineering applications; accordingly, additional applications of the air compressor apparatus 20 will be readily apparent to those skilled in the art. The air compressor apparatus 20 may comprise a rotary air compressor. In certain embodiments, the air compressor is selected from the group comprising a screw air compressor, a scroll air compressor, a vane air compressor, and a lobe air compressor. In one embodiment, the air compressor apparatus 20 may comprise a modular component of the locomotive engine 1. The air compressor apparatus 20 may comprise at least a connection element 30 and a roller assembly 29 that increases the modularity and/or portability of the air compressor apparatus 20 and allows the air compressor apparatus 20 to be rolled out of the locomotive engine 1. In one embodiment, the disconnection of all of the connection elements 30 of the air compressor apparatus 20 may cause the air compressor apparatus 20 to be fully supported by the roller assembly 29 thereby allowing an associated operator to roll the air compressor apparatus 20 out of the locomotive engine 1 via a side door 9 of the operator cab 5 wherein the air compressor apparatus 20 can then be picked up utilizing a tow motor or pole and then moved to a desired location for servicing or storing the air compressor apparatus 20. The air compressor apparatus 20 may comprise any type of air compressor chosen with sound judgment by a person of ordinary skill in the art.

With reference now to FIGS. 1-5, 13-16, in one embodiment, the drive assembly 12 may comprise a diesel engine that is operatively connected to a generator and the radiator assembly 26 thereby providing motive power to the locomotive engine 1. The generator may be operatively connected to the engine and may provide three-phase power to components of the locomotive engine 1. In one embodiment, drive assembly may comprise a modular component that allows the drive assembly to be readily installed and/or removed from the locomotive engine 1. In a more specific embodiment, the drive assembly may comprise a modular component comprised of one or more separately modular components. In one embodiment, the drive assembly may comprise a modular component comprised of a modular engine and a modular generator such that the entire drive assembly or the engine and/or the generator may be separately removed from the locomotive engine 1. The generator may comprise a modular component that allows for the installation and/or removal of a component of the generator providing a phase or leg of the power supplied to the locomotive engine 1 thereby allowing for the repair or replacement of only the defective or non-working component of the generator. In one embodiment, each modular component of the modular drive assembly may comprise a roller assembly 29 and connection elements 30 described below.

The auxiliary power unit may comprise a high-powered auxiliary power unit that provides a sufficient amount of power to drive the locomotive engine 1 independently. The auxiliary power unit may comprise a relatively compact power unit having a design that increases the ease in which the auxiliary power unit may be serviced. In one embodiment, the auxiliary power unit may be driven or controlled by a APU computer. The APU computer may drive or control the auxiliary power unit by controling the operation of an APU generator that is operatively connected to the APU computer. The APU computer may be remotely mounted to the auxiliary power unit and may be located in the operator cab of the locomotive engine 1. The auxiliary power unit may comprise a modular component that can be independently installed and/or removed from the locomotive engine 1. In one embodiment, the auxiliary power unit may comprise a plurality of connection elements 30 and a roller assembly that increases the modularity and/or portability of the auxiliary power unit and allows the auxiliary power unit to be rolled out of the locomotive engine 1. In one embodiment, the auxiliary power unit may comprise a fuel connection element, a power connection element, and an exhaust connection element. The fuel, power, and exhaust connection elements may allow the auxiliary power unit to be readily installed and/or removed from the locomotive engine 1. In one embodiment, the disconnection of the fuel, power, and exhaust connection elements may cause the auxiliary power unit to be fully supported by the roller assembly thereby allowing an associated operator to roll the auxiliary power unit out of the locomotive engine 1 via a side door 9 wherein the auxiliary power unit 23 can then be picked up utilizing a tow motor or pole and then moved to a desired location for servicing or storing the auxiliary power unit 23.

The auxiliary power unit 23 may comprise a generator portion and an IGBT device portion. The generator portion may comprises a generator that is operatively connected to an insulated gate bipolar transistor (IGBT) device that is matched to the output potential of the generator of the auxiliary power unit and the requirements of the traction motors operatively connected to the drive wheels. The IGBT device may be matched to the output potential of the generator and the requirements of the traction motors by determining the power required to move the locomotive engine 1 and the necessary current associated with the traction motors for moving the locomotive engine 1 and obtaining a predetermined amount of speed as can be accomplished by a person of ordinary skill in the art without requiring undue experimentation. The generator portion may comprise a frame, a relatively large housing having windings positioned therein, and an armature. The armature may be sized for 125 kW and may be incorporated into a 100 kW package to allow for a high surge voltage and amperage draw necessary to cause the locomotive engine 1 to begin moving from a fully stopped position. By providing the armature sized for 125 kW the life or longevity can be extended. The IGBT device may comprise a bridge, first and second switching rectifiers incorporating line frequency transformers or IGBT choppers, and a rectifier assembly. In one specific embodiment, the bridge may be designed to transform an input signal comprising an input voltage of about 480 volts and an input AC current comprising about 65 amperes into an output signal comprising an output voltage of about 400 volts and an output DC current comprising about 1200 amperes. The output signal may comprise the necessary “in-rush” required to be provided to the traction motors to cause the locomotive engine 1 to initially move from a fully stopped position. In one embodiment, a current in the range of about 600-700 amperes may be required to be provided to the traction motors to cause the locomotive engine 1 to initially move from a fully stopped position. Upon causing the locomotive engine 1 to begin moving, the power required to move the locomotive engine 1 is reduced. The reduced power requirement may allow the IGBT device portion to cause the output signal to be ramped down or transformed. In one specific embodiment, the IGBT device portion may cause the output signal to comprise an output voltage comprising about 700 volts and an output DC current comprising about 400 amperes. The generator may comprise a generator control circuit for controlling the operation of the generator. The generator control circuit may be designed and sized to allow for the momentary in-rush required to initially move the locomotive engine 1 from a fully stopped position without adversely affecting the operation of the generator.

With reference now to FIGS. 1-5, 13-16, in one embodiment, the locomotive engine 1 may comprise one or more modular components. The modular components may allow the component to be independently installed or removed from the locomotive engine 1 without requiring the installation or removal of other components of the locomotive engine 1. In one embodiment, the modular components may allow for the interchanging of like modular components such that a first modular component comprising a first type of component may be readily swapped out, interchanged, or replaced with a second modular component also comprising the first type of component. The modular components may be readily installed and removed because the installation or removal of the modular components do not require the additional time, effort, or cost to installed or removed other components as required with conventional, non-modular components included in conventional engines. In one embodiment, the modular components comprise a connection element 30 that facilitates the independent installation and/or removal of the modular component. The connection element 30 may comprise an element that facilitates the independent installation and/or removal of the modular component by specifically adapting the modular component, wherein such adaptations may include, but are not limited to, design selection for accessibility, design selection for ease of connection and disconnection, the use of quick-connection fluid components, and/or the use quick-connection mechanical fasteners. In one embodiment, one of the modular components may comprise quick-connection mechanical fasteners such as, for example, quarter-turn fasteners. In one embodiment, one of the modular components may comprise quick-connection fluid components such as, for example, quick connection clamps, or quick connection couplers. In one embodiment, one of the modular components may comprise rollers or a roller assembly (described below) to facilitate installation or removal of the modular component from the locomotive engine 1. In one embodiment, the modular components may comprise a light weight that allows the modular component to be removed from the locomotive engine 1 by a tow motor or pole, not shown. In one embodiment, the modular components are adapted to be installed or removed from the locomotive engine 1 with less than eight man hours of work. The modular components may comprise, without limitation, the traction control system 14, the central control system 16, the AESS system 17, an air compressor apparatus 20, a power unit 22, a braking system 24, and a radiator assembly 26.

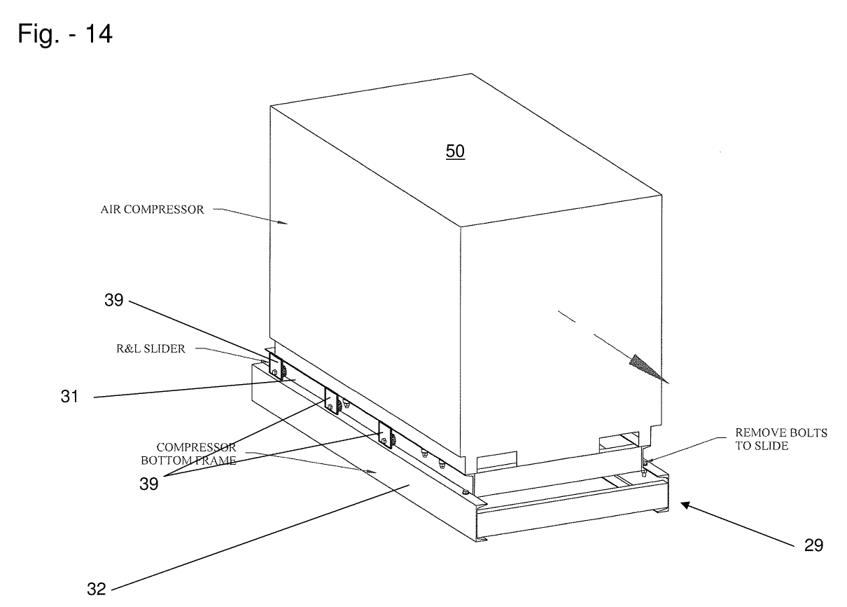

With reference to FIGS. 14-16, the modular components 50 of the locomotive engine 1 may each comprise a roller assembly 29. The roller assembly 29 may enable the ready installation, and/or removal of the modular component by facilitating the mounting and/or removal of the component. In one embodiment, the roller assembly 29 may comprise a slider assembly 31 and a bottom frame assembly 32. The slider assembly may comprise a right channel 33 and a left channel 34 positioned substantially parallel to the right channel 33. A plurality of center channels 35 may extend between the right and left channels 33, 34 substantially perpendicular thereto to form a base suitable to receive the modular component, for example, the air compressor apparatus 20 or auxiliary power unit 23. In one embodiment, the slider assembly 31 may comprise a first and second center channels 35 extending between opposing ends of the right and left channels 33, 34 and a third center channel 35 extending between the substantial centers of the right and left channels 33, 34. The bottom frame 32 assembly may comprise right and left channels 36, 37 positioned substantially parallel to each other and suitable to receive at least a portion of the right and left channels 33, 34 of the slider assembly 31 thereby at least partially enabling the movement or sliding of the modular component across the upper surface defined by the bottom frame assembly 32. The bottom frame assembly 32 may also comprise a plurality of center channels 38 similar to the center channels 35 of the slider assembly 31. The slider assembly 31 may comprise a plurality of rotating assemblies 39 rotatably connected to the right and left channels 33, 34 of the slider assembly 31. The rotating assemblies 39 may allow the slider assembly 31 to be sliding connected to and removable from the base frame assembly 32 thereby facilitating the ready installation and/or removal of the modular component. The rotating assemblies 39 may allow the slider assembly 31 to be slid across the upper surface defined by the bottom frame assembly 32 to a position removed from the bottom frame assembly 32 such that the rotating assemblies 39 contact the bottom surface of the operator cab 5 and/or the locomotive frame 2 thereby allowing the modular component to be rolled off the locomotive engine 1.

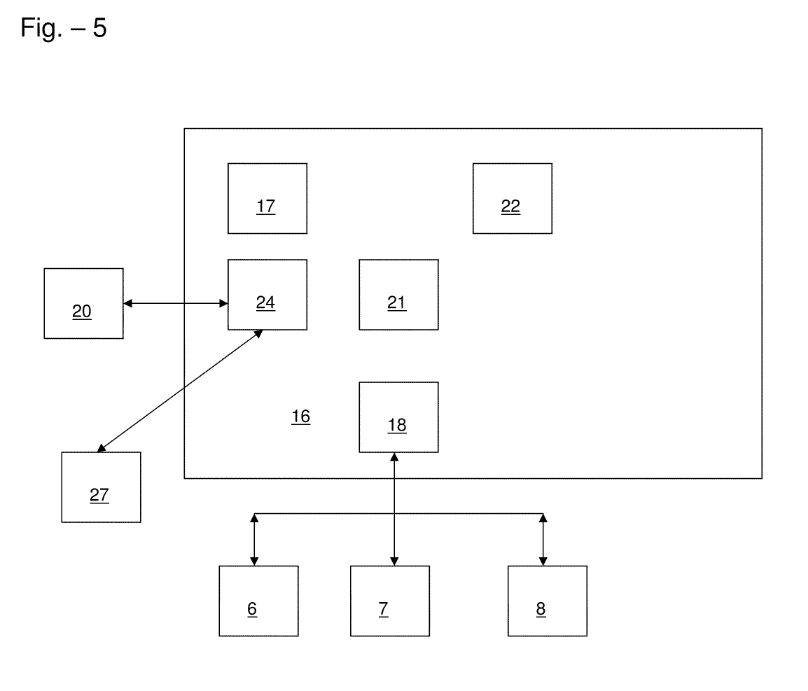

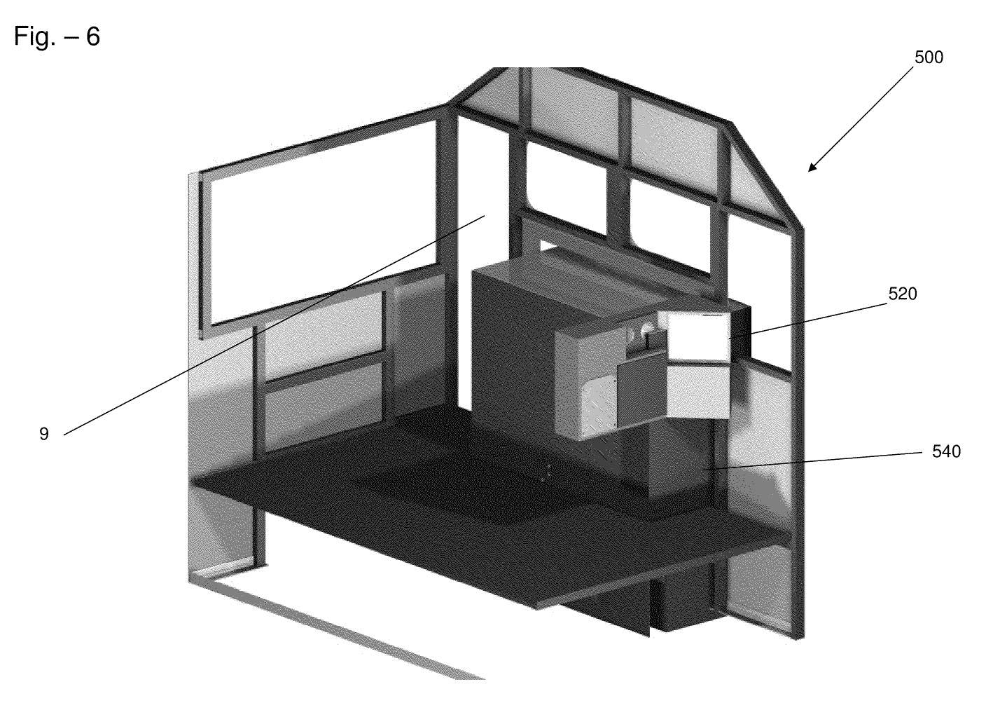

With reference now to FIGS. 6-12, in one embodiment, the locomotive engine 1 may comprise an operator compartment 500. FIGS. 5-11 depict various elements of one embodiment of an operator compartment 500. In some embodiments, the operator compartment 500 may be adapted for ergonomics. In some embodiments, the operator compartment 500 may comprise a control stand 520. In some embodiments the region under the control stand 520 may comprise a free space 540 under the control stand 520 lacking airbrake piping or conduits or other components. The free space 540 under the control stand 520 may improve ergonomics and may permit an operator to work at the control stand 520 with a decreased risk of bumping knees or feet.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A locomotive engine comprising:
a centralized computer control comprising:
an automated engine start and stop system;
an engine heater control; and,
a cooling fan control;
a traction control system comprising:
a first sensor for determining slippage conditions at a first wheel; and,
a switching control adapted to switch power to and from the first wheel; and,
an air compressor apparatus.

2. A locomotive engine comprising:
a modular centralized computer control comprising:
an automated engine start and stop system;
an engine heater control; and,
a cooling fan control;
a modular traction control system comprising:
a first sensor for determining slippage conditions at a first wheel; and,
a switching control adapted to switch power to and from the first wheel;
a modular air compressor apparatus;
a modular main power unit comprising:
a first internal combustion engine;
a first alternator adapted to provide three-phase alternating current; and,
a first chopper,
a modular auxiliary power unit comprising:
a second internal combustion engine;
a second alternator adapted to provide three-phase alternating current; and,
a second chopper;
a modular braking system; and,
a modular radiator assembly,
wherein the modular main power unit provides a first amount of power sufficient to drive the apparatus while the apparatus is operatively connected to at least a first railroad car and the modular auxiliary power unit provides a second amount of power sufficient to drive the apparatus.

3. A modular component for a locomotive engine comprising:
a connection element for facilitating the ready installation or removal of the modular component; and,
a roller assembly comprising:
a slider assembly having a first channel, a second channel and a plurality of center channels extending between the first and second channels, wherein the first, second, and center channels define a first upper surface suitable to receive the modular component;
a bottom frame assembly having a third channel, a fourth channel, and a plurality of center channels extending between the third and fourth channels, wherein the third and fourth channels are suitable to receive at least a portion of the first and second channels respectively; and,
a plurality of rotating assemblies rotatably connected to the first and fourth channels, wherein the plurality of rotating assemblies allow the slider assembly to slide across an upper surface of the bottom frame assembly defined by the third, fourth and center channels of the bottom frame assembly.
